(19) United States
(12) Patent Application Publication
(10) Pub. No.: US 2009/0100015 A1
(43) Pub. Date: Apr. 16, 2009

(54) WEB-BASED WORKSPACE FOR ENHANCING INTERNET SEARCH EXPERIENCE

(76) Inventor: Alon GOLAN, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/870,526

(22) Filed: Oct. 11, 2007

(51) Int. Cl. G06F 17/30

(52) U.S. Cl. 707/3; 707/E17.108

(57) ABSTRACT

A comprehensive web based workspace, or search and navigation environment that supports the user throughout an Internet search session and beyond. Specifically, any search session is performed through the workspace which is a web based application that enables the user to log in and identify. The workspace tracks and analyzes the search pattern of the user, learns and characterizes it and provides him or her with ever improving search results, targeted advertisements and other relevant information on-the-fly. Specifically, the workspace is capable of monitoring each and every hypertext document (including URLs) visited by the user. Additionally, the workspace further enables a user to create a cluster search materials comprising URLs and downloaded files. The cluster is used by the workspace to further optimize the search. Moreover—the cluster may be shared between users.

### FIELD OF THE INVENTION

The present invention relates generally to an Internet search and browsing environment and more specifically, to enhancing Internet search and navigation by providing a dedicated web-based active workspace.

### BACKGROUND OF THE INVENTION

Improving search and navigation capabilities over the Internet has been an ongoing challenge ever since online databases have become ubiquitous. As more and more people rely on the Internet as a primary source of knowledge, the demand for efficient and focused search increases. The classic search methodology has been for years in the form of a search engine, usually a dedicated web site that enables a user to enter in a query encapsulating the required information by the user.

The operation of a typical search engine starts when a user enters a query, which is a set of search terms related to the type of content for which he or she is searching. The query is transmitted to the search engine, which attempts to locate relevant content over the Internet. The related content which is the output of a search engine is usually in the form of “hits”, i.e. uniform resource locators (URL), images, audio and video files, as well as content in dedicated file formats and the like.

Search engines are usually implemented by computer programs executing upon remote server computers representing nodes to the computer network and through which individual users connect to the network. However, the search engines are confined to performing the search solely via their website. Currently, it is difficult to perform a search and navigate outside the search engine site while enjoying the search improvement and refinements techniques employed by the search engines.

The search query that often lies at the heart of the currently available search tools is usually a very limited search element. According to researches, a typical query comprises on average only two keywords. Clearly, no searcher is able to define his or her search object using a string that comprises of only two words. Therefore, optimizing and personalizing the search process over the Internet remains an ongoing challenge. Many attempts have been made in recent years in order to improve the Internet search process. One approach has been to create a dynamic search engine that tracks the user's activities while he or she uses the search engine. Another approach concentrates on the web browser, where tracking and monitoring of the user are supposed to teach about his or her interests.

US Patent Application No. 20050125382 which is incorporated by reference herein in its entirety discloses a method for gathering context-based feedback from the user while the user is searching the Internet. This method studies the user and is implemented within a web browser.

US Patent Application No. 20060224579 which is incorporated by reference herein in its entirety discloses a system comprising a learning component that analyzes stored information retrieval data to determine relevance patterns from past user information search activities. The system resides on the client's computer therefore software installation is required here as well.

US Patent Application No. 20060161520 which is incorporated by reference herein in its entirety discloses a search engine and related logic may examine the search string for suggested refinements or improvements to the search terms, to attempt to derive improved results or results closer to the user's search intent. The drawback with a search engine is that it can only tracks the user up to the point where he or she leaves the search engine and browse further and deeper in the “hits”.

US Patent Application No. 20060122979 which is incorporated by reference herein in its entirety discloses Search results are processed using search requests, including analyzing received queries in order to provide a more sophisticated understanding of the information being sought. A concept network is generated from a set of queries by parsing the queries into units and defining various relationships between the units. Again, this system has the drawbacks of a search engine, not being able to fully track and analyze the user's activities outside the search engine site.

US Patent Application No. 20060100956 which is incorporated by reference herein in its entirety discloses an internet search engine database with the results of a user's selection of specific web page listings from the general web page listing provided to the user as a result of his initial keyword search entry. By updating the database with the selections of many different users, the database can be updated to prioritize those web listings that have been selected the most with respect to a given keyword

US Patent Application No. 20050256846 which is incorporated by reference herein in its entirety discloses an interactive client-server data search involves accepting search-related inputs from a user at a client and having the search performed on a data collection at a server. To reduce transmission latencies, the client pre-fetches search results prior to input from the user. When a user indicates that a search is to be requested, the client pre-fetches a sparse subset of data of a size that is sufficient to fill a search results display area of the client regardless of a first input character. In other words, a number of possible results for each character that might be first input is pre-fetched from the server.

### SUMMARY OF THE INVENTION

The present invention takes a unique and different approach for the Internet search process. According to this approach, the Internet user is provided with a comprehensive active workspace, or search environment, that supports him or her throughout the search session and beyond. As opposed to presently available web browsers or search engines, any search session is performed exclusively through the workspace so that all of the user's reactions to the search results as well as his or her behavior during navigation may be analyzed and stored.

In this application the term “search results” relates to search results presented to the user after invoking a s query, as well as any material such as URLs, files of any type format or kind, advertisements and the like that may be presented to the user by any means throughout the search session.

The workspace is a web based application that allows the user to log in and perform an Internet search via the workspace. At any time during the search, the workspace applications track the navigation and search pattern of the user, learn and characterize it and provide the user with ever improving search results, related information and targeted advertisements on-the-fly.

According to a first aspect of the invention, the user starts with a basic query. In return the workspace provides the user with search results using a standard search engine. Then the workspace tracks and analyzes the user's reaction to the search results and records the user actions and reaction to the initial search result and the following drill down links. The workspace applications also track and analyze other events of the user's behavior such as page saving, content printing, clicks on links etc. This information of the user's reaction in conjunction with the context of the search results are used by the workspace applications to generate a personalized, optimized and/or refined query on the fly. The query is then searched automatically and refined and/or newer search results and/or advertisement and/or other relevant information are suggested and presented to the user.

According to a second aspect of the invention, the workspace comprises a backend module that resides remotely on a server computer and a graphical user interface (GUI) that is presented on the client computer. The GUI may be similar to a webmail environment. Specifically, the GUI may comprise a portion dedicated to incoming search results and other relevant links or information that resembles the incoming emails in a web mail environment. The GUI further comprises a preview portion through which the user may get a preview of selected search results

According to a third aspect of the invention, throughout the search session, the user is presented with more search results, targeted advertisements and relevant information that reflect the search pattern and the user's ad hoc interest as the search and navigation evolve. The suggested search results or relevant links and information may be presented as a message comprising a bundle of search results or link/s. The message may have a title describing the nature of the bundle and so a user may know upon the arrival of such a message what characterizes the new incoming bundle of search results or link/s. Then, the workspace application rates the messages according to, inter alia, opened messages and the amount or popularity of search results or links in the message that has been visited. It thus further may also dynamically refines and optimizes the queries throughout the search session.

According to a fourth aspect of the invention, the workspace is able to monitor the history of each and every URL and document visited by the user during the entire search session, providing session history footsteps that characterize the user's interests. Although the actual history records are stored on the user's computer and are not accessible, the workspace is able to reconstruct list of visited URLs. Usually, only parent URLs are presented to the user as “hits” is the search results. The workspace maps the logic architecture of such a parent URL with its entire child URLs (by receiving all the child URLs from the parent URL's server). Then the workspace goes through and checks each and every URL via the user's browser and checks its color. Since visited URLs are assigned with a different color than the not visited URLs, the workspace can easily determine which URL has been visited.

According to a fifth aspect of the invention, the user is enabled and encouraged to create and save a personalized cluster of search results and other pages or content. The cluster is basically the all the search results accumulated by the user throughout a search session (or multiple search sessions) and the workspace navigation. The cluster reflects the material that has been subjectively regarded relevant by the user. The search results in the cluster, files downloaded of any kind and type. The cluster represents the so called ‘search harvest’ of the user, and specifically what the user thought as important enough to store for future reference. In addition to storing the material the workspace further allows the user to arrange the search materials in the cluster according to a predefined order or hierarchy. The order or inner hierarchy of the clusters may be in the form of tags and sub-tags that are searchable for users via the workspace.

According to a sixth aspect of the invention, the personalized cluster of search results may be shared between users, with or without relation to the profile of the user who created the cluster. Thus, users may search for personalized clusters of search results according to their inner order or hierarchy, as well as according to their respective profile of their creators. Alternatively, users of the workspace may receive such clusters as search results in addition to the regular search results.

According to a seventh aspect of the invention, users may also perform “group search” by searching together, at the same time or on separate time, from separate clients. During the above “group search” users can save and share relevant information and search results at the same clusters or tags and may chat with each other during their common search session.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a schematic state diagram showing the evolvement of the search session according to the present invention;

FIG. 2 is a schematic block diagram of the system according to the present invention;

FIG. 3 is a flow chart diagram showing the steps of the method according to the present invention;

FIG. 4 shows schematically the graphical user interface according to some embodiments of the present invention;

FIG. 5 is a schematic block diagram showing a tree representation of a visited URL; and

FIG. 6 is a schematic block diagram showing the structure of a personalized cluster of search results.

The drawings together with the description make apparent to those skilled in the art how the invention may be embodied in practice.

Further, where considered appropriate, reference numerals may be repeated among the figures to indicate corresponding or analogous elements.

### DETAILED DESCRIPTION OF THE INVENTION

This application is related to U.S. patent application Ser. No. 11/602,700 entitled “Method and System for Real-time Active Refinement of Search Results” filed on Nov. 22, 2006 and is incorporated herein by reference in its entirety.

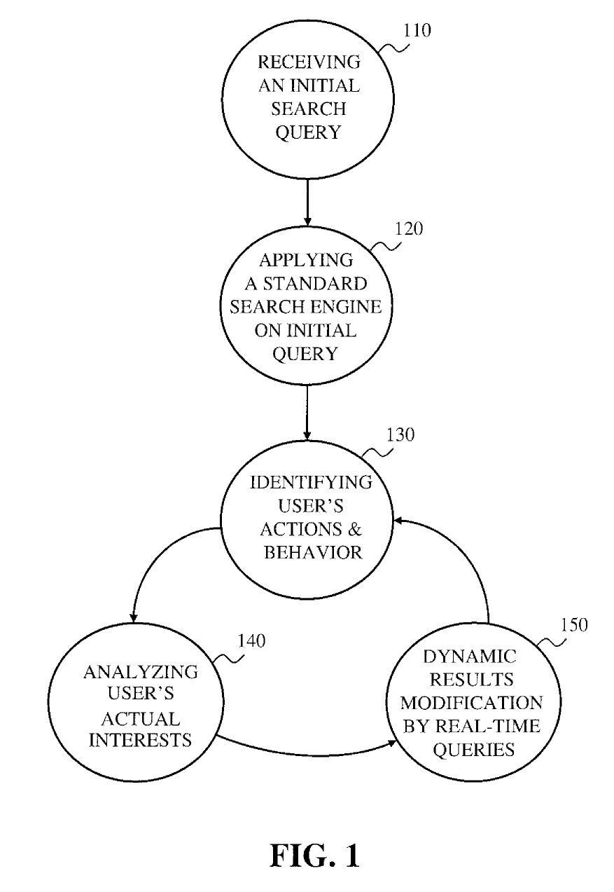

FIG. 1 shows a schematic state diagram showing the evolvement of the search session according to the present invention. In order to use the disclosed workspace, the user starts with a basic query 110. In return, the workspace provides the user with search results using a standard search engine 120. Then the workspace tracks and analyzes the reaction of the user to the search results and records the user actions and reaction to the initial search result 130. The workspace is capable of identifying which search results were opened or downloaded by the user, the length of time the user spent in each search result and the like. In addition, a contextual analysis of each and every search result visited by the user is performed 140. This information of the user's reaction in conjunction with the context of the relevant search results is used by the workspace to generate a personalized and optimized modified query 150. The query is then searched automatically and the newer search results are presented to the user and so forth—states 130, 140 and 150 reoccur.

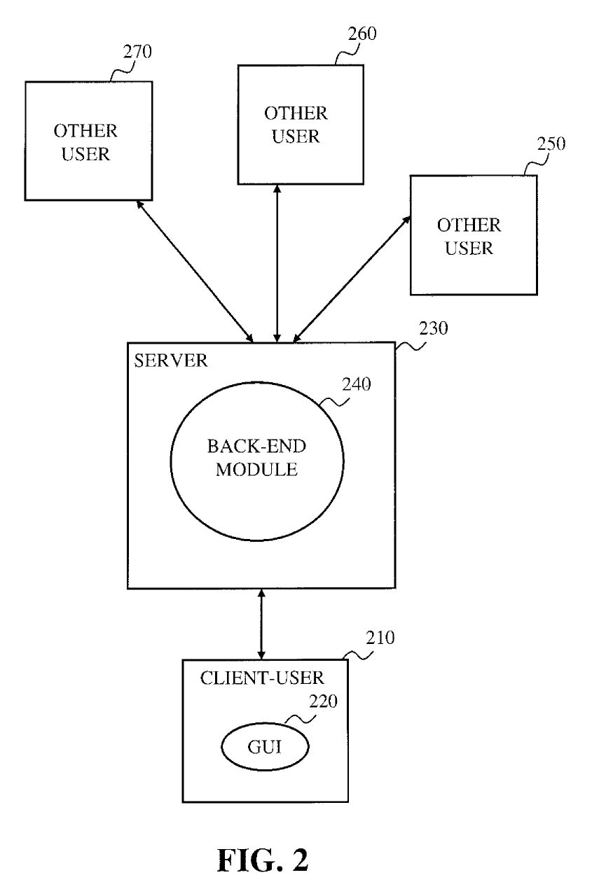

FIG. 2 shows a schematic block diagram of the system according to the present invention. The workspace comprises a backend module 240 that resides remotely on a server computer 230 and a graphical user interface 220 (GUI) that is presented on the client computer 210. The server computer 230 in connected via the Internet to other users 160, 170, 180. This configuration allows a user to enter the workspace from every client computer and carry-on his or her unique profile. By this the present invention differs from a browser which is limited locally to a single client.

According to some embodiments of the invention, a user will not have to identify to the system and any use of the workspace will not require registration.

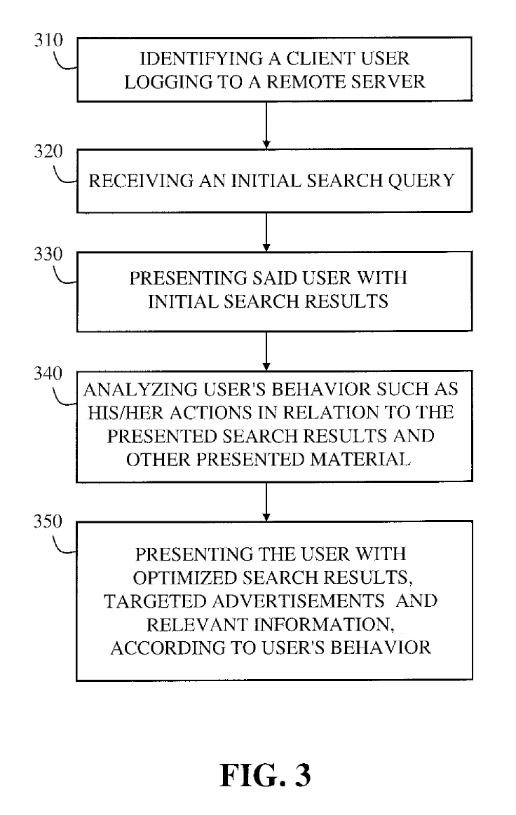

FIG. 3 is a flow chart diagram showing the steps of the method according to some embodiments of the present invention. The search session starts with identifying a client user logging to a remote server 310. In other embodiments logging in is not required and the user may start a search session by simply entering the web site of the workspace. It follows by receiving an initial search query 320. The next step is presenting said user with initial search result 330. Then the next step is tracking user's browsing through presented search results 340. The next step is presenting the user with optimized search results according to user's browsing 350. the steps goes on as 340 and 350 enable further refinement and personalizing of the search thus enhancing the total search experience over the Internet.

According to some embodiments of the invention, the optimization of the search results is achieved using a two-layer algorithm. On the first layer, a URLs and documents-based search is done by digging up relevant keywords based on lexical, semantic information from the visited websites and documents. On the second layer, a Session-based tracking is performed by monitoring any actual user's behavior. For any purpose, in this application the user's behavior is defined as any physical and virtual action initiated by the user on the client's computer and is observable by the workspace.

More specifically, the query optimization process on both of the aforementioned layers utilizes weighting the extracted information in view of the context of the URL and the documents visited by the user as well as the user's behavior. On the URLs and documents layer the optimization of the query is affected by the parameters of the URLs and document visited. These parameters may comprise, for example, the source of the URL or document (government, commercial, educational, personal); the format of the URL or document (hypertext documents, texts, images, combination thereof, types of file formats); its complexity (amount of links, images, multimedia resources, and advertisement banners). Thus, the method and system according to the present invention may extract relevant information regarding the target audience of the visited URLs and documents thereby deducting on the user's real interests.

On the session based layer the method and system according to the present invention learns the user's behavior during the entire search session. The relevance of the user relates to specific documents and URLs may be learnt by the fact that the user has visited specific documents and URLs and chose to ignore others. Any other behavior related to the chosen documents and URLs, such as saving, printing, sending as an email to a friend etc. may be used by the workspace to deduce relevancy.

According to some embodiments of the invention, the workspace suggests the user a reformulation of his or her search query in response to the user's behavior. The reformulation is an improved representation of the data that is sought after, as opposed to merely refinement where only narrowing of the scope is performed. The reformulating is performed in light of the user's respond to the search results that are presented to him or her on the fly throughout the search session

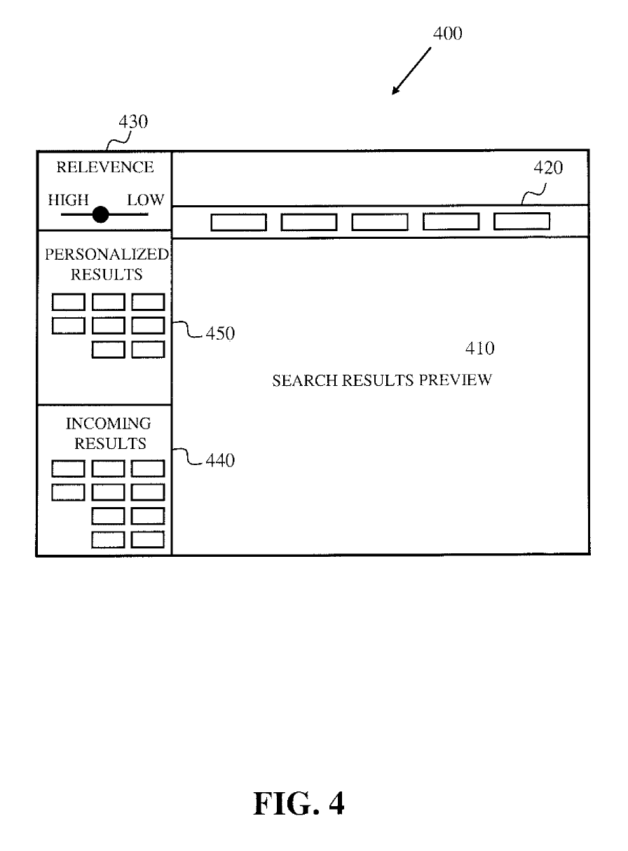

FIG. 4 shows an example for the graphical user interface (GUI) according to the present invention. According to some embodiments, the GUI 400 imitates a standard webmail environment. The GUI comprises a portion dedicated to incoming search results 440 that resembles the incoming emails in a webmail environment. Each incoming ‘message’ is actually a bundle of search results that has been sent either from the workspace's backend or another user. The GUI further comprises a portion 450 dedicated to personalized results and material presented to the user. The user may arrange and store some of these results and other material in this portion. The GUI further comprises a preview portion 410 through which the user may get a preview of selected search results. In the case that the search result is a URL, the preview may be in the form of a frame, allowing the user to browse through the website before opening it. Other forms of preview may be available for different types and file formats of the search results. Another portion is the relevance indicator 430 where the user is enabled to rate each and every search results deliberately. In addition, a plurality of tool buttons 420 are available to the user to choose various actions such as zoom in, ignore, save, print, mark etc, by which the user may browse more easily on one handle and allow the workspace to further track the user's activity.

According to some embodiments of the invention, choosing specific search results, sent in the form of an incoming message in the aforementioned webmail environment may further infer the workspace of a relevancy related to these search results by the user, thus providing more information to the workspace as to the real interest of the user.

According to some embodiments of the invention, the user will be presented with focused advertisements. The advertisements will change frequently in accordance with the actual interests of the user as manifested from his or her activities. The advertisements, similarly as newer search results, may be optimized by both the URL and document-based monitoring and the session based monitoring and tracking.

According to some embodiments of the invention, the GUI may resemble a browser running Java script and html. It may comprise a stand alone application which is web-based or alternatively be implemented within a web browser.

According to some embodiments of the invention part of the GUI comprises incoming search results portion 440 which resembles a webmail's inbox showing the incoming search results in which the user may click upon and open. These incoming search results keep coining throughout the search session according to the user's behavior. Another view is that of the personalized search results 450. The user may choose to store, arrange, share and perform a variety of operations on these clusters. Clearly, the workspace follows these activities and learns on the user's real interests. Yet another view is the history footstep (not shown) where the user is presented with the websites he or she visited during the current session, thus visualizing the search process. This may be used in conjunction with the personalized cluster—showing the history footstep required to build a particular cluster and providing the user with a better understanding on the search process.

According to some embodiments of the invention, throughout the search session, the user is presented over the GUI with further search results that reflect the search pattern and the user's ad hoc interest as the search evolves. The search results may be presented as a message comprising a bundle of search results. The message may have a title describing the nature of the bundle and so a user may know upon the arrival of such a message what characterizes the new incoming bundle of search results. Then, the workspace rates the messages, inter alia, according to opened messages and the amount of search results in the message that has been visited. It thus further optimizes the search session.

According to some embodiments of the invention, the workspace tracks and analyzes not only the reactions of the user to the search results presented to him or her, but any action performed on his or her computer, including any action performed over the browser such as using a toolbar button, storing a URL (as in ‘favorites’), erasing a result, printing the URL and sharing thereof. Additionally, while the user browses through the preview screen provided over the GUI, any further activity, such as clicking on links or ads will be monitored, as well as any action of the user's mouse such as moving the cursor, rolling up and down, marking specific lines etc.

According to some embodiments of the invention, the workspace may block access to specific content in accordance with predefined parameters. Thus, the interactive workspace may be used as a safe and restricted search tool avoiding access to offensive content.

According to some embodiments of the invention, the GUI provides the user with context related tags that open up in accordance to new search results. This facilitates the graphical representation and access to new search results. The workspace may track the user's behavior in relation to these tags and further deduce therefrom the real interest of the user throughout the search session.

According to some embodiments of the invention, logging and registering to the workspace would be conditional for the premium usage. The premium usage will include the ability to store search results, as well as to create and share personalized clusters of search results.

In addition to providing the user with updated search results on the fly and in accordance with the user's behavior, the workspace may present the user with additional material such as focused ads, back-links (web pages that provide links to the present web page), relevant news, relevant imaged and even URL (or any hypertext document) that are relevant for the user, such as results from amazon.com, ebay.com as well as relevant posts from blog websites.

According to some embodiments of the invention, the workspace monitors and may present to the user, the history session footsteps. This is a URL tree showing the history of the sites visited during the last session. The URL (or any hypertext document) tree may be stored by the user or be included in relevant clusters/tags, for quick access in the future.

The Workspace will also enable several users on different client-computers to perform a shared search, wherein the different users shall be able to share the results, as well as the personalized cluster of search results. Additionally they may engage in a chat concerning the search.

According to some embodiments of the invention, the user is enabled to selectively classify the search results in either a top-down or a bottom-up manner. This will enable, later, a quick access to the stored material as well as serve as basis for monitoring and tracking of the interests of the user.

The use of the workspace is by no means limited to the Internet network. Any online database may benefit from such a workspace. The workspace may be implemented to work with an Intranet or any organizational network. The workspace may, for similar reasons be implemented within an Internet protocol television (IPTV). The workspace may be implemented within any PDA with wireless connectivity, such as cellular phones, Palm pilots and the like.

According to some embodiments of the invention, the workspace may operate in a semi automatic configuration. According to the semi-automatic configuration, the workspace receives the information regarding the user and automatically presents the user with suggested URL for further visiting. For example, using the “I'm feeling lucky” button of Google.com. After selecting a specific search result, the workspace identifies the field of interest of the user and presents him or her with similar URL's.

According to some embodiments of the invention the workspace is able to recognized and identify the user's activities in every URL he or she is visiting. This differentiates the workspace of the present invention from regular search engines that can only track the user whenever he or she is using the search engine.

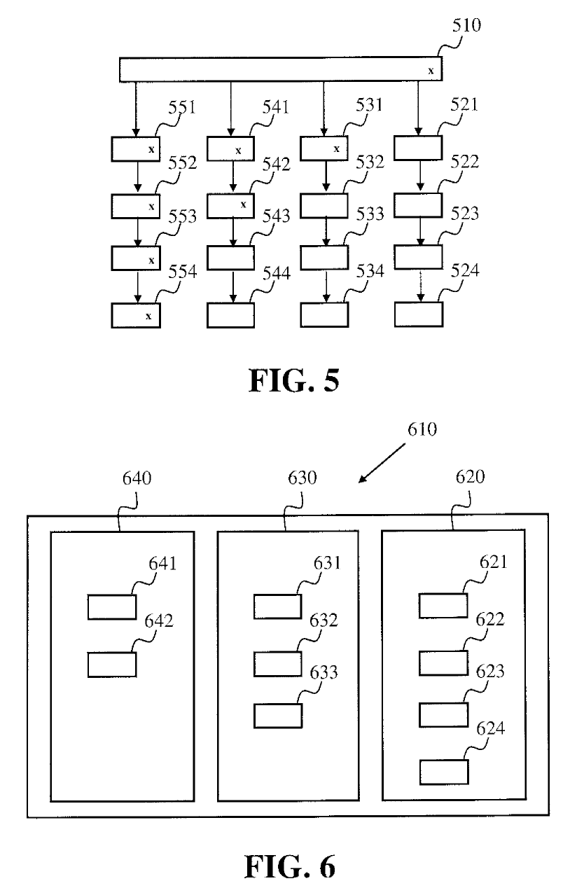

FIG. 5 is a schematic block diagram showing a tree representation of a visited URL. A parent URL 510 is presented as a search result to the user. The workspace is able to monitor the history of each and every URL visited by the user during the entire search session. Although the actual history records are stored on the user's computer and are not accessible, the workspace is able to reconstruct list of visited URLs. Usually, only parent URLs are presented to the user as “hits” is the search results. The workspace maps the logic architecture of such a parent URL with its entire child URLs 521-524, 531-534, 541-544, 551-554. Then the workspace goes through each and every URL via the browser and checks its mark up for visited URLs, usually the color of the URL. Since visited URLs are assigned with a different color than the not visited URLs, the workspace can easily determine which URL has been visited. In FIG. 5, child URLs 531, 541, 542, 551, 552, 553, and 554 were visited by the user. Thus the history is reconstructed by the workspace. This information further allows the workspace to monitor the websites visited far beyond the ability of standard search engines.

FIG. 6 is a schematic block diagram showing the structure of a personalized cluster of search results, according to some embodiments of the invention. The user is enabled and encouraged to create a personalized cluster of search results and other content 610. The cluster is basically the all the search results accumulated by the user throughout a search session (or multiple search sessions). The cluster reflects the material that has been subjectively regarded relevant by the user. The search results in the cluster, files downloaded of any kind and type. The cluster may comprise several sections 620, 630, 640, each relating to a different type of search results. Specifically, 621-624 may relate to text files, 631-633 may relate to image files and 641-642 may relate to URLs. The cluster represents the so called ‘search harvest’ of the user, and specifically what the user thought as important enough to store for future reference. In addition to storing the material the workspace further allows the user to arrange the search materials in the cluster according to a predefined order or hierarchy. The order or inner hierarchy of the clusters may be in the form of tags and sub-tags that are searchable for users via the workspace.

According to some embodiments of the invention, the personalized cluster of search results may be shared between user, with or without relation to the profile who created the cluster. Thus, users may search for personalized clusters of search results according to their inner order or hierarchy, as well as according to their respective profile of their creators. Alternatively, users of the workspace may receive such clusters as search results in addition to the regular search results.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A web-based workspace for enhancing a networked database search experience throughout a search session, said workspace comprising:
a graphical user interface (GUI) located on a client computer; connected via a network to
a backend module located on a remote server;
wherein said GUI enables a user to enter a search query and wherein said backend module applies said search query on a search engine and returns initial results to the user via the GUI;
and wherein the GUI enables the user to browse through search results and related URL via said backend module and wherein said backend module tracks and analyzes said user's browsing and behavior, wherein the user's behavior comprises every physical and virtual action initiated by the user on the client's computer which is observable by the workspace;
and wherein said backend module dynamically returns further search results on the fly throughout the search session in conjunction with relevant information in accordance with the user's browsing and behavior.

2. The workspace according to claim 1, wherein said network is at least one of the following: the Internet, an Ethernet network, an intranet network, a local computer network.

3. The workspace according to claim 1, wherein the search results are any material presented to the user by the workspaces throughout the search session, wherein the search results comprise at least one of the following: hypertext documents, unified resource locators (URLs), text files, image files, audio files, video files, advertisements.

4. The workspace according to claim 3, wherein the backend module tracks and analyzes the browsing of the search results by the user by mapping the web logic of any hypertext document and URL that has been presented as a search result and further by detecting any child URL that has been browsed by the user according to the standard browser mark up for visited URLs.

5. The workspace according to claim 4, wherein the backend module creates a tree of visited URLs for each URL search result presented to the user and wherein said tree is used to personalize further search results presented to the user.

6. The workspace according to claim 4, wherein the standard browser mark up for visited URLs is by changing the color of the URL.

7. The workspace according to claim 3, wherein the backend module creates a user profile according to the content and type of search results visited by the user and the length of time that the user spent visiting each search result.

8. The workspace according to claim 3, wherein the user is enabled to arrange and store a plurality of search results in a personalized cluster of search results.

9. The workspace according to claim 8, wherein said personalized cluster of search results is arranged by the user according to the user's priorities.

10. The workspace according to claim 8, wherein a user is enabled to share said personalized cluster of search results with other users.

11. The workspace according to claim 4, wherein the GUI is in the form of a webmail interface, wherein the search results are returned to the user in the form of an incoming message.

12. The workspace according to claim 11, wherein the GUI enables preview of search results.

13. The workspace according to claim 11, wherein the GUI enables the user to see the websites he or she visited during the current session, thus showing the history footstep, and wherein the workspace is further configured to track and analyze the user's action regarding the presented history footsteps.

14. The workspace according to claim 1, wherein the backend module presents the user with advertisements over the GUT in accordance with the user's browsing and behavior.

15. A method for enhancing networked database search and navigation experience, said method comprising the steps of:
enabling a user to connect to a remote server;
receiving an initial search query;
presenting said user with initial search result;
tracking user's browsing and behavior presented search results;
presenting the user with at least one of the following: optimized search results, targeted advertisements, relevant information according to user's browsing and behavior.

16. The method according to claim 15, wherein said initial search results comprise a plurality of hypertext documents.

17. The method according to claim 16, wherein—tracking user's browsing through presented hypertext documents comprise the steps of mapping the web logic of each hypertext document visited by the user, and detecting each visited child hypertext documents of said presented hypertext document, and wherein said detection is according to standard browser mark up of visited hypertext documents.

18. The method according to claim 17, wherein the hypertext document is a URL.

19. The method according to claim 15, further comprising the step of enabling a user to store and arrange a cluster of personalized search results.

20. The method according to claim 19, further comprising the step of enabling a user to share said cluster of personalized search results.

21. The method according to claim 20, wherein further optimization of the search results is achieved by learning the user's behavior regarding clusters of personalized search results of other users.

22. A system for enhancing a networked database search experience, said system comprising:
means for identifying a client user logging to a remote server;
means for receiving an initial search query;
means for presenting said user with URLs relevant to said initial search query;
means for tracking user's browsing through presented search results and user's behavior;
means for presenting the user with optimized search results according to user's browsing and behavior.

23. The system according to claim 22 further comprising means for blocking access to content in accordance with predefined parameters.

24. The system according to claim 22 further comprising means for reformulating said search query in response to the user's behavior, wherein said reformulation is an improved representation of said query for the data that is searched by the user in light of the user's behavior in response to the search results.
